(19) United States
(12) Patent Application Publication
(10) Pub. No.: US 2010/0142497 A1
(43) Pub. Date: Jun. 10, 2010

(54) METHOD FOR TRANSMITTING DATA AND METHOD FOR RECEIVING DATA

(75) Inventors: Kyeong Tae KIM, Chuncheon-si (KR); Byung Tae Jang, Daejeon (KR); Jeong Dan CHOI, Daejeon (KR); Do Hyun KIM, Daejeon (KR); Jaejun YOO, Daejeon (KR); Jeong Ah JANG, Daejeon (KR); Kyung Bok SUNG, Daejeon (KR); Jungsook KIM, Daejeon (KR); Jae Han LIM, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/630,293

(22) Filed: Dec. 3, 2009

(30) Foreign Application Priority Data
Dec. 4, 2008 (KR) 10-2008-0122729
Jun. 19, 2009 (KR) 10-2009-0055140

(51) Int. Cl. H04B 7/212; H04J 3/16

(52) U.S. Cl. 370/337; 370/336

(57) ABSTRACT

Provided is a method for minimizing energy consumption while increasing a data rate between sensor nodes in a sensor network. In the sensor network, a parent node receives reservation information from a first node among a plurality of child nodes in a first period and broadcasts channel allocation information of the first node according to the reservation information in the first period so that the first node performs the data transmission in a second period or third period and maintains a sleep mode until the first period ends.

### CROSS-REFERENCE TO RELATED APPLICATION

This application claims priority to and the benefit of Korean Patent Application Nos. 10-2008-0122729 and 10-2009-0055140 filed in the Korean Intellectual Property Office on Dec. 4, 2008 and Jun. 19, 2009, the entire contents of which are incorporated herein by reference.

### BACKGROUND OF THE INVENTION

(a) Field of the Invention

The present invention relates a method for transmitting data and a method for receiving data. In particular, the present invention relates to a method for transmitting data and a method for receiving data in a wireless sensor network.

(b) Description of the Related Art

A method for allowing a sensor node to save energy in a wireless sensor network is achieved by periodically repeating a sleep interval and a wake-up interval. When there are data to be transmitted by a sensor node, the sensor node transmits packets in the wake-up interval.

At this time, a ratio of a wake-up interval to the entire interval that is a sum of the sleep interval and the wake-up interval is referred to as a duty cycle. The shorter the duty cycle, the higher the energy efficiency becomes.

However, when the sleep interval and the wake-up interval is repeated, since the scheduling of each sensor node and adjacent sensor nodes should match each other, there is a disadvantage in that a time synchronization protocol is needed and the scheduling information of the adjacent sensor nodes should be maintained.

Further, if the duty cycle is minimized in order to minimize energy consumption, when there is a lot of communication traffic between the sensor nodes, many sensor nodes contend for channels during a short time to cause collision, such that data loss occurs and data rate reduces.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method for increasing data rate and minimizing energy consumption between sensor nodes in a sensor network.

A method for receiving data according to the present invention is a method for receiving data from a plurality of child nodes by a parent node in a sensor network including the parent node and the plurality of child nodes. The method for receiving data includes: receiving first reservation information that includes a size of data to be transmitted by a first node among the plurality of child nodes from the first node in a first period; broadcasting first channel allocation information on the first node based on the first reservation information in the first period so that the first node performs data transmission in a second or third period; and maintaining a sleep mode from the broadcasting of the first channel allocation information to a time when the first period ends.

The method for receiving data may further include receiving first data from the first node in the second period, and maintaining the sleep mode from the receiving of the first data to a time when the second period ends.

Further, the first period, the second period, and the third period may include a contention interval, a control interval, a transmission interval, or a sleep interval.

In addition, in the receiving of the first reservation information in the method for receiving data, the parent node receives the first reservation information in the contention interval of the first period, in the broadcasting of the first channel allocation information in the method for receiving data, the parent node broadcasts the first channel allocation information in the control interval of the first period, and in the maintaining of the sleep mode to the time when the first period ends in the method for receiving data, the parent node may maintain the sleep mode from a time when the control interval of the first period ends to a time when the first period ends.

In the receiving of the first data of the method for receiving data, the parent node receives the first data in the transmission interval of the second period by the parent node, and in the maintaining of the sleep mode to a time when the second period ends in the method for receiving data, the parent node maintains the sleep mode from a time when the transmission interval of the second period ends to a time when the second period ends.

In addition, any one of the first period, the second period, and the third period may include one or more transmission intervals.

The method for receiving data may further include: receiving second reservation information that includes a size of data to be transmitted by a second node among the plurality of child nodes from the second node in a contention interval of a first period; broadcasting the second channel allocation information on the second node based on the second reservation information in the control interval of the second period prior to the receiving the first data so that the second node performs data transmission in the third period; receiving second data from the first node in a first transmission interval of the third period by the parent node; receiving third data from the second node in a second transmission interval of the third period after receiving the second data; and maintaining the sleep node from a time when the second transmission interval of the third period ends to a time when the third period ends.

A method for transmitting data according to another aspect of the present invention is a method for transmitting data to a parent node by one of a plurality of child nodes in a sensor network including the parent node and the plurality of child nodes. The method for transmitting data includes: attempting occupation of a contention interval of a first period; transmitting reservation information that includes node identification information and size information of data to be transmitted to the parent node in the contention interval of the first period, when the child node occupies the contention interval of the first period; receiving control information that includes the node identification information and channel allocation information from the parent node in the control interval of the first period; maintaining a sleep mode of the first period from the receiving of the control information to a time when the first period ends; and transmitting first data to the parent node in a transmission interval of a second period according to the channel allocation information.

In the attempting of the method for transmitting data, the child node may attempt the occupation of the contention interval of the first period according to the plurality of child nodes and a carrier sensing multiple access scheme.

Also, the method for transmitting data further includes maintaining the sleep mode in a sleep interval of the second period from a time when the transmission interval of the second period ends to a time when the second period ends.

### BRIEF DESCRIPTION OF THE DRAWINGS

FIG. 1 is a diagram showing a configuration of a wireless sensor network according to an exemplary embodiment of the present invention;

FIG. 2 is a diagram showing a configuration of one period in a communication channel between a parent node and a child node according to an exemplary embodiment of the present invention;

FIG. 3 is a diagram showing a data communication method according to an exemplary embodiment of the present invention;

FIG. 4 is a diagram showing a structure of a first period according to an exemplary embodiment of the present invention.

FIG. 5 is a diagram showing a structure of a second period according to an exemplary embodiment of the present invention.

FIG. 6 is a diagram showing a structure of a third period according to an exemplary embodiment of the present invention; and

FIG. 7 is a diagram showing a structure of an inter-node communication frame according to another exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the specification, unless explicitly described to the contrary, the word “comprise” and variations such as “comprises” or “comprising” will be understood to imply the inclusion of stated elements but not the exclusion of any other elements.

Hereinafter, a method for transmitting data and a method for receiving data in a wireless sensor network according to an exemplary embodiment of the present invention will be described with reference to the accompanying drawings.

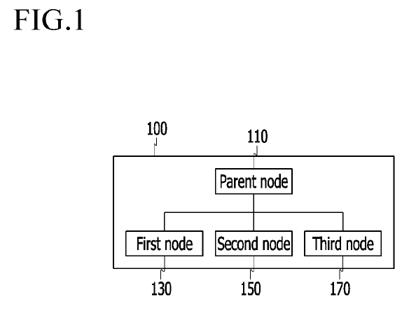

Referring first to FIG. 1, a wireless sensor network according to an exemplary embodiment of the present invention will be described.

FIG. 1 is a diagram showing a configuration of a wireless sensor network according to an exemplary embodiment of the present invention.

As shown in FIG. 1, a wireless sensor network 100 includes a parent node 110 and a plurality of child nodes, that is, a first node 130, a second node 150, and a third node 170.

The parent node 110 repeats a wake-up period and a sleep period based on a predetermined period, and receives data through a predetermined channel from a plurality of child nodes during the wake-up period.

The plurality of child nodes, that is, each of the first node 130, the second node 150, and the third node 170, repeat the wake-up period and the sleep period based on a predetermined period and transmit data to the parent node through the predetermined channel during the wake-up period.

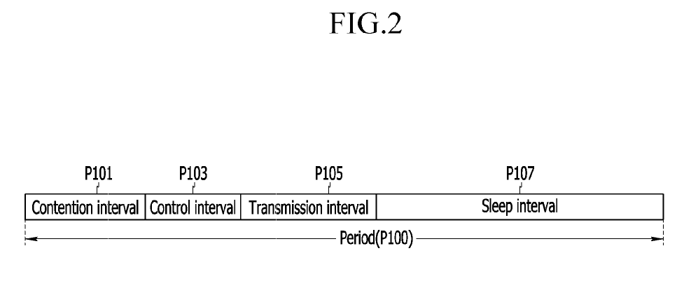

Next, referring to FIG. 2, a configuration of one period in a communication channel between the parent node and the child node according to an exemplary embodiment of the present invention will be described.

FIG. 2 is a diagram showing a configuration of one period in the communication channel between the parent node and the child node according to an exemplary embodiment of the present invention.

As shown in FIG. 2, one period P100 in the communication channel between the predefined parent node and child node includes a contention interval P101, a control interval P103, a transmission interval P105, and a sleep period P107. At this time, the contention interval P101, the control interval P 103, and the transmission interval P105 correspond to the wake-up period.

The contention interval P101 is a period where the plurality of child nodes contend with each other to use a channel.

The control interval P103 is a period where the parent node 110 broadcasts time synchronization information and channel allocation information to a plurality of child nodes.

The transmission interval P105 is a period where any one of the plurality of child nodes transmits data to the parent node 110 according to the channel allocation information. At this time, the transmission interval P105 is a period that does not cause a collision between the plurality of child nodes. Further, the length of the transmission interval P105 can be increased or reduced when the plurality of child nodes have a large amount of data to be transmitted.

The sleep period P107 is a period that minimizes energy consumption by switching a central processing unit or a communication module to a sleep mode by the parent node and the plurality of child nodes.

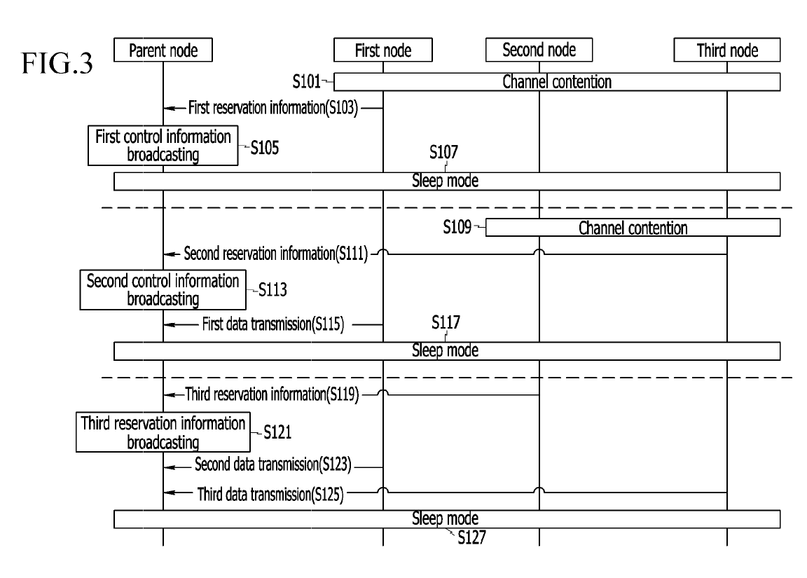

Next, a data communication method between the parent node and the plurality of child nodes in the sensor network according to an exemplary embodiment of the present invention will be described with reference to FIGS. 3 to 6.

FIG. 3 is a diagram showing the data communication method according to an exemplary embodiment of the present invention.

First, as shown in FIG. 3, when each of a plurality of child nodes of the sensor network 100, that is, the first node 130, the second node 150 and the third node 170 has data to be transmitted to the parent node 110, the first node 130, the second node 150, and the third node 170 attempt occupation of the contention interval of a first period through the channel contention (S101). At this time, the first node 130, the second node 150, and the third node 170 can attempt the occupation of the contention interval of the first period in the contention interval of the first period. For example, the first node 130, the second node 150, and the third node 170 can attempt the channel occupation according to a carrier sense multiple access/collision avoidance (hereinafter referred to as CSMA/CA) scheme.

Next, when the first node 130 occupies the contention interval of the first period according to the result of the channel contention, the first node 130 transmits first reservation information that includes the identification information of the first node 130 and the size information of data to be transmitted by the first node 130 to the parent node (S103). At this time, the first node 130 can transmit the first reservation information in the contention interval of the first period.

Thereafter, the parent node 110 broadcasts first control information that includes the identification information of the first node 130 and the first channel allocation information based on the first reservation information (S105). At this time, the parent node 110 can broadcast the first control information in the control interval of the first period. Further, the first channel allocation information includes information on the transmission interval to be allocated to the first node 130 according to the size information of data of the first reservation information. Also, when the length of the transmission interval is predefined, the parent node 110 can allocate a plurality of transmission intervals according to the size information of data.

Next, the parent node 110, the first node 130, the second node 150, and the third node 170 maintain a sleep mode during a predetermined time (S107).

At this time, the parent node 110, the first node 130, the second node 150, and the third node 170 can maintain the sleep mode from the time when the control interval of the first period ends to the time when the first period ends. At this time, each of the parent node 110, the first node 130, the second node 150, and the third node 170 switches a central processing unit or a communication module into a sleep mode.

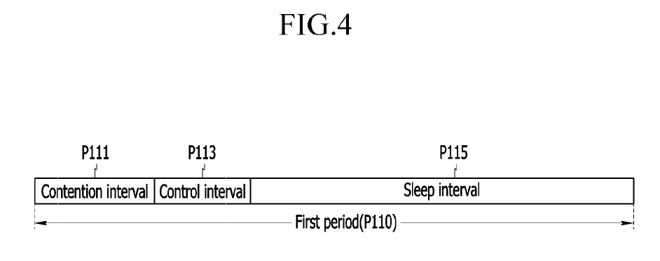

Hereinafter, a structure of the first period according to an exemplary embodiment of the present invention will be described with reference to FIG. 4.

FIG. 4 is a diagram showing a structure of a first period according to an exemplary embodiment of the present invention.

As shown in FIG. 4, the first period P110 includes a contention interval P111, a control interval P113, and a sleep interval P115.

In the contention interval P111 of the first period P110, the first node 130, the second node 150, and the third node 170 can attempt the occupation of the contention interval P111 through the channel contention, and the first node 130 occupying a channel can transmit the first reservation information to the parent node 110.

Also, in the control interval P113 of the first period P110, the parent node 110 can broadcast the first control information.

Further, in the sleep interval P115 of the first period P110, the parent node 110, the first node 130, the second node 150, and the third node 170 can switch the central processing apparatus or the communication module into a sleep mode.

Referring back to FIG. 3, except for the first node to which the channel is allocated, the second node 150 and the third node 170 having data to be transmitted to the parent node 110 attempt the occupation of a contention interval of a second period through the channel contention (S109). At this time, the second node 150 and the third node 170 can attempt the occupation of the contention interval of the second period in the contention interval of the second period according to the CSMA/CA scheme.

Next, according to the result of the channel contention occupation attempt, when the third node 170 occupies the contention interval of the second period, the third node 170 transmits second reservation information that includes the identification information of the third node 170 and the size information of data to be transmitted by the third node 170 to the parent node 110 (S111). At this time, the third node 170 can transmit the second reservation information in the contention interval of the second period.

Thereafter, the parent node 110 broadcasts second control information that includes the identification information of the third node 170 and second channel allocation information based on the second reservation information. (S113). At this time, the parent node 110 can broadcast the second control information during the control interval of the second period. Further, the second channel allocation information includes information on the transmission interval to be allocated to the third node 170 according to the information of the data size of the second reservation information.

Next, the first node 130 transmits first data to the parent node 110 according to the first control information (S115). At this time, the first node 130 can transmit the first data in the transmission interval of the second period according to the first channel allocation information.

Thereafter, the parent node 110, the first node 130, the second node 150, and the third node 170 maintain the sleep mode during the predetermined time (S117). At this time, the parent node 110, the first node 130, the second node 150, and the third node 170 can maintain the sleep mode from the time when the transmission interval of the second period ends to the time when the second period ends.

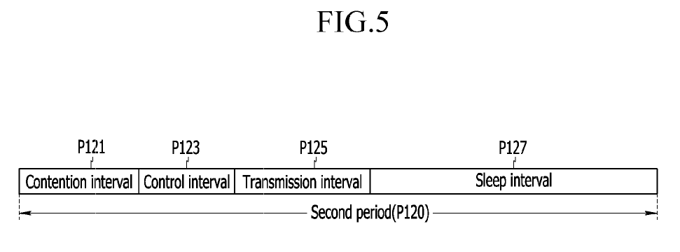

Hereinafter, a structure of the second period according to an exemplary embodiment of the present invention will be described with reference to FIG. 5.

FIG. 5 is a diagram showing the structure of the second period according to an exemplary embodiment of the present invention.

As shown in FIG. 5, the second period P120 include a contention interval P121, a control interval P123, a transmission interval P125, and a sleep interval P127.

In the contention interval P121 of the second period P120, the second node 150 and the third node 170 may attempt the occupation of the contention interval P121 through the channel contention, and the third node 170 occupying the channel may transmit the second reservation information to the parent node 110.

In addition, in the control interval P123 of the second period P120, the parent node 110 may broadcast the second control information.

In addition, in the transmission interval P125 of the second period P120, the first node 130 can transmit the first data to the parent node 110.

Further, in the sleep interval P127 of the second period P120, the parent node 110, the first node 130, the second node 150, and the third node 170 can switch the central processing unit or the communication module to the sleep mode.

Referring back to FIG. 3, the second node 150 having data to be transmitted except for the first node and the third node to which the channel is allocated occupies a contention interval of a third period to transmit third reservation information that includes the identification information of the second node 150 and the size information of data to be transmitted by the second node 150 to the parent node 110 (S119). At this time, the second node 150 can transmit the third reservation information during the contention interval of the third period. In addition, since there is no node that attempts the occupation of the contention interval of the third period, the second node 150 can occupy the contention interval without the channel contention.

Thereafter, the parent node 110 broadcasts third control information that includes the identification information of the second node 150 and the channel allocation information based on the third reservation information (S121). At this time, the parent node 110 can broadcast the third control information during the control interval of the third period. In addition, the third channel allocation information includes the information of the transmission interval that will be allocated to the second node 150 according to the data size information of the third reservation information.

Next, the first node 130 transmits second data to the parent node 110 according to the first control information (S123). At this time, the first node 130 can transmit the second data in a first transmission interval of the third period according to the first channel allocation information.

Thereafter, the third node 170 transmits third data to the parent node 110 according to the second control information (S125). At this time, the third node 170 can transmit the third data in a second transmission interval of the third period according to the second channel allocation information.

Next, the parent node 110, the first node 130, the second node 150, and the third node 170 maintain the sleep mode during the predetermined time (S127). At this time, the parent node 110, the first node 130, the second node 150, and the third node 170 can maintain the sleep mode from the time when the second transmission interval of the third period ends to the time when the third period ends.

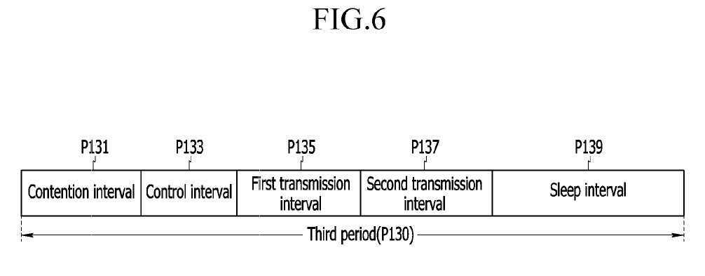

Hereinafter, the structure of the third period according to an exemplary embodiment of the present invention will be described with reference to FIG. 6.

FIG. 6 is a diagram showing a structure of a third period according to an exemplary embodiment of the present invention.

As shown in FIG. 6, the third period P130 includes a contention interval P131, a control interval P133, a first transmission interval P135, and a second transmission interval P137, and a sleep interval P139.

At this time, in the contention interval P131 of the third period P130, the second node 150 occupying a channel may transmit the third reservation information to the parent node 110.

Further, in the control interval P133 of the third period P130, the parent node 110 may broadcast the third control information.

In addition, in the first transmission interval P135 of the third period P130, the first node 130 may transmit the second data to the parent node 110.

In addition, in the second transmission interval P137 of the third period P130, the third node 170 may transmit the third data to the parent node 110.

Further, in the sleep interval P137 of the third period P130, the parent node 110, the first node 130, the second node 150, and the third node 170 can switch the central processing unit or the communication module to the sleep mode.

As the above-described, when data to be transmitted to the parent node 110 is small, the transmission interval is minimized and the sleep mode is increased as much as possible, making it possible to minimize a duty cycle, and when data are transmitted, they are transmitted through the previously reserved transmission interval without colliding with other nodes, making it possible to minimize the transmission delay.

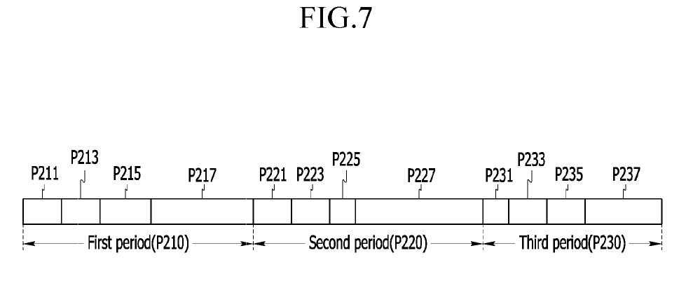

Next, a structure of an inter-node communication frame according to another exemplary embodiment of the present invention will be described with reference to FIG. 7.

FIG. 7 is a diagram showing a structure of an inter-node communication frame according to another exemplary embodiment of the present invention.

The parent node 110 and the plurality of child nodes can be operated in an asynchronous manner, and one period can be dynamically changed according to a traffic amount between the parent node 110 and the plurality of child nodes. At this time, the parent node 110 monitors the plurality of child nodes in the contention interval, making it possible to allocate the transmission interval to the child nodes having data to be transmitted.

When the parent node 110 allocates the transmission interval to any one child node, the length of the allocated transmission interval is determined according to a period where the channel collision occurs or the period where noise exists in the channel.

At this time, the parent node 110 can determine the length of the transmission interval according to the number of overheard data or the data transmission time of the child node.

Also, the length of the allocated transmission interval is proportional to a period when the channel collision occurs, a period where noise exists in the channel, the number of overheard data, or the data transmission time of the child node.

As shown in FIG. 7, the first period P210 includes a first contention interval P211, a first control interval P213, a first transmission interval P215, and a first sleep interval P217, the second period P220 includes a second contention interval P221, a second control interval P223, a second transmission interval P225, and a second sleep interval P227, and the third period P230 includes a third contention interval P231, a third control interval P233, a third transmission interval P235, and a third sleep interval P237.

The first period P210, the second period P220, and the third period P230 may have different lengths. At this time, each length of the first transmission interval P215, the second transmission interval P225, and the third transmission interval P235 may be allocated to be different from each other. Also, each length of the first sleep interval P217, the second sleep interval P227, and the third sleep interval P237 may be allocated to be different from each other.

The parent node 110 can dynamically control the length of the contention interval based on the channel situation observed at a proceeding period, for example, two proceeding periods. At this time, the parent node 110 can dynamically allocate the length of the contention interval according to the length of the sleep interval and the length of the transmission interval of the proceeding period. Also, the length of the allocated contention interval may be inversely proportional to the length of the sleep interval and the length of the transmission interval of the proceeding period.

The length of the third contention interval P231 can be allocated to be different from that of the first contention interval P211 and the second contention interval P221. At this time, the parent node 110 may determine the length of the third contention interval P231 based on the length of the first sleep interval P217 and the length of the second sleep interval P227. Also, the parent node 110 may determine the length of the third contention interval P231 based on the length of the first transmission interval P215 and the length of the second transmission interval P225.

Thereby, the parent node 110 dynamically sets a length of each interval to be optimized to the channel situation, making it possible to improve the performance of the wireless sensor network.

An embodiment of a data communication method base on the structure of the inter-node communication frame as shown in FIG. 7 can be easily devised from the description of the above-mentioned exemplary embodiments based on FIG. 3 by those skilled in the art to which the present invention pertains. Therefore, detailed description on the embodiment of a data communication method base on the structure of the inter-node communication frame as shown in FIG. 7 will be omitted.

According to the embodiments of the present invention, the data transmission interval is controlled in one period according to an amount of traffic and data is transmitted without colliding with other nodes through previously reserved transmission intervals when transmitting data, thereby making it possible to minimize energy consumption while increasing the data rate between sensor nodes in the sensor network.

The above-mentioned exemplary embodiments of the present invention are not embodied only by a method and apparatus. Alternatively, the above-mentioned exemplary embodiments may be embodied by a program performing functions that correspond to the configuration of the exemplary embodiments of the present invention, or a recording medium on which the program is recorded. These embodiments can be easily devised from the description of the above-mentioned exemplary embodiments by those skilled in the art to which the present invention pertains.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for receiving data from a plurality of child nodes by a parent node in a sensor network including the parent node and the plurality of child nodes, comprising:
receiving first reservation information that includes a size of data to be transmitted by a first node among the plurality of child nodes from the first node in a first period;
broadcasting first channel allocation information on the first node based on the first reservation information in the first period so that the first node performs data transmission in a second or third period; and
maintaining a sleep mode from the broadcasting of the first channel allocation information to a time when the first period ends.

2. The method for receiving data of claim 1, further comprising:
receiving first data from the first node in the second period; and
maintaining the sleep mode from the receiving of the first data to a time when the second period ends.

3. The method for receiving data of claim 2, wherein
the first period, the second period, and the third period include
a contention interval, a control interval, a transmission interval, or a sleep interval.

4. The method for receiving data of claim 3, wherein,
in the receiving of the first reservation information, the parent node receives the first reservation information in the contention interval of the first period,
in the broadcasting of the first channel allocation information, the parent node broadcasts the first channel allocation information in the control interval of the first period, and
in the maintaining of the sleep mode to a time when the first period ends, the parent node maintains the sleep mode from a time when the control interval of the first period ends to a time when the first period ends.

5. The method for receiving data of claim 3, wherein,
in the receiving of the first data, the parent node receives the first data in the transmission interval of the second period, and
in the maintaining of the sleep mode to a time when the second period ends, the parent node maintains the sleep mode from a time when the transmission interval of the second period ends to a time when the second period ends.

6. The method for receiving data of claim 3, wherein
any one of the first period, the second period, and the third period includes one or more transmission intervals.

7. The method for receiving data of claim 6, further comprising:
receiving second reservation information that includes a size of data to be transmitted by a second node among the plurality of child nodes from the second node in the contention interval of the first period;
broadcasting the second channel allocation information on the second node based on the second reservation information in the control interval of the second period prior to the receiving the first data so that the second node performs data transmission in the third period;
receiving second data from the first node in a first transmission interval of the third period by the parent node;
receiving third data from the second node in a second transmission interval of the third period after receiving the second data; and
maintaining the sleep node from a time when the second transmission interval of the third period ends to a time when the third period ends.

8. A method for transmitting data to a parent node by one of a plurality of child nodes in a sensor network including the parent node and the plurality of child nodes, comprising:
attempting occupation of a contention interval of a first period;
transmitting reservation information that includes node identification information and size information of data to be transmitted to the parent node in the contention interval of the first period, when the child node occupies the contention interval of the first period;
receiving control information that includes the node identification information and channel allocation information from the parent node in the control interval of the first period;
maintaining a sleep mode of the first period from the receiving of the control information to a time when the first period ends; and
transmitting first data to the parent node in a transmission interval of a second period according to the channel allocation information.

9. The method for transmitting data of claim 8, wherein
In the attempting, the child node attempts the occupation of the contention interval of the first period according to a carrier sensing multiple access scheme.

10. The method for transmitting data of claim 8, further comprising
maintaining the sleep mode in a sleep interval of the second period from a time when the transmission interval of the second period ends to a time when the second period ends.
